(19) United States
(12) Patent Application Publication
(10) Pub. No.: US 2011/0038613 A1
(43) Pub. Date: Feb. 17, 2011

(54) REMOTE STORAGE OF DIGITAL MEDIA BROADCASTS FOR TIME-SHIFTED PLAYBACK ON PERSONAL DIGITAL MEDIA DEVICES

(76) Inventor: BRIAN K. BUCHHEIT, DAVIE, FL (US)

Correspondence Address: PATENTS ON DEMAND, P.A.-General, 4581 WESTON ROAD, SUITE 345, WESTON, FL, 33331, US

(21) Appl. No.: 12/540,919

(22) Filed: Aug. 13, 2009

(51) Int. Cl. H04N 7/26

(52) U.S. Cl. 386/297; 386/299; 386/240; 386/250; 386/201

(57) ABSTRACT

A solution is presented where a DVR user interface can be enhanced to record selected broadcasts in a networked data store remote from the local device. A link to remotely stored media files can be maintained by the local device, which is selectable by a user for playback via the DVR user interface. A user of the local device may be unaware of whether a selected recording is locally stored or is maintained in the networked data store. A user can access media recorded via the DVR user interface and stored in the networked data store from multiple different devices. The media in the networked data store can be optionally stored in different fidelities and formats, so that media transmissions from the networked data store are provided in a fidelity and format best suited for the receiving device.

### BACKGROUND

The present invention relates to the field of digital media accessibility and, more particularly, to remotely storing digital media broadcasts for time-shifted playback on personal media devices.

Over the past few decades, the transmission, storage, and presentation of data used in our daily lives has been transitioning from analog to digital formats. For example, vinyl records and cassette tapes have been replaced with compact discs (CDs) and downloadable music files, commonly referred to by a common format, MP3, as the primary means of recording, storing, conveying, and playing audio music. Television broadcasts, from both local and/or cable networks, have started this same type of transition. In fact, many cable television networks broadcast exclusively in the digital format.

The shift in television broadcasts to the digital format reduces bandwidth requirements and provides a simple means to carry digitally encoded information, sometimes bidirectional within the carrier wave of the broadcasts. Further, digital broadcasts are often streamed or transmitted over an IP network for presentation on a myriad of digital devices, such as video-capable iPods, mobile phones, and other portable video devices. Digital video recorders (DVRs) or personal video recorders (PVRs) are often utilized to record broadcasts for time shifted playback. Currently, most DVRs are physically discrete devices able to receive broadcasts and output these broadcasts to a display. Controls on DVRs are somewhat analogous to video recorder controls with an inclusion of a broadcast guide for selecting broadcasts that are to be recorded. Unfortunately, many conventional DVRs are unable to natively exchange data with a user's other digital media devices in formats that are mutually compatible. For example, a digital television broadcast captured by a conventional DVR cannot be easily or intuitively shared to the user's video-capable iPod. These data exchange incompatibilities often result from digital rights management (DRM) issues, from fidelity issues and from incompatibilities in supported encoding formats. Conventional solutions designed to overcome data exchange capabilities focus on providing local, user executable software tools, which convert stored files from one format to another. This process is largely a manual one that requires a substantial technical knowledge lacking in many users, is computing resource and time intensive, and is often intentionally impeded through strategic use of copy preventive measures implemented by a broadcaster or rights owner of the broadcasted media.

Limits of the storage and bandwidth resources of a DVR and/or a media playback device are also problematic. The use of higher-quality digital formats results in larger media files. Larger media files require more storage space on the DVR and the digital media device as well as more time and/or bandwidth for transmission between the devices. An end result of these issues is that DVR recorded media is typically not available from other digital media devices, such as mobile phones, video IPODs, or a remote DVR device (a friend's DVR, for example), even though this would be a capability desired by many users.

### BRIEF DESCRIPTION OF THE SEVERAL VIEWS OF THE DRAWINGS

FIG. 1 is a schematic diagram illustrating a system that provides device-independent remote recording/storage of digital media programs in accordance with embodiments of the inventive arrangements disclosed herein.

FIG. 2 is a flowchart of a method detailing use of the remote digital media handling service from the user's perspective in accordance with an embodiment of the inventive arrangements disclosed herein.

FIG. 3 is a flow chart of a method that describes the capture of digital media programs by the remote digital media recorder in accordance with embodiments of the inventive arrangements disclosed herein.

FIG. 4 is a flow chart of a method detailing the provision of captured digital media programs by the remote digital media recorder in accordance with embodiments of the inventive arrangements disclosed herein.

FIG. 5 is an illustrated sequence of interactions depicting use of the remote digital media handling service in accordance with embodiments of the inventive arrangements disclosed herein.

FIG. 6 is a communication flow between the entities involved in the remote recording of digital media programs in accordance with embodiments of the inventive arrangements disclosed herein.

FIG. 7 is a collection of graphical user interfaces (GUIs) for interacting with the remote digital media handling service in accordance with embodiments of the inventive arrangements disclosed herein.

FIG. 8 is a collection of digital media device components that incorporate hardware mechanisms for accessing the remote digital media handling service in accordance with embodiments of the inventive arrangements disclosed herein.

### DETAILED DESCRIPTION

The disclosure presents a solution where a DVR user interface from a local device can be enhanced to record selected broadcasts in a networked data store remote from the local device. A link (e.g., a URL or other identifier) to remotely stored media files can be maintained by the local device, which is selectable by a user for playback via the DVR user interface. In one embodiment, a user of the local device may be unaware of whether a selected recording is locally stored or is maintained in the networked data store. In one embodiment, a user can access media recorded via the DVR user interface and stored in the networked data store from multiple different devices. Further, the media in the networked data store can be optionally stored in different fidelities and formats, so that media transmissions from the networked data store are provided in a fidelity and format best suited for the receiving device. Effectively, a user specific DVR recording schedule and media repository can be maintained that is device independent, which is accessible from any compatible DVR user interface.

In one embodiment, synchronization actions can be automatically and transparently performed between a local drive and the networked data store to ensure that recorded media anticipated as being most likely to be viewed is present in the local drive. Further, a portion of media files (e.g., a first five minutes) can be optionally stored locally while the remainder is on a network data store to prevent delays in playback upon selection, while minimizing consumption of local storage space. Thus, a virtual storage space (e.g., the networked storage space) can effectively extend the capabilities of the more limited local storage space, which is typically a hard constraint imposed by DVR hardware.

In one embodiment, networked storage space can be optimized by maintaining a single recording for multiple users. For example, only a single recording of a popular prime-time show needs to be maintained in the network storage space regardless of a number of individuals who have opted to store this recording via a DVR interface linked to the networked storage space. In one embodiment, advertisements associated with a media broadcasts stored in the networked data store can be substituted and/or replaced at a time of playback. Moreover, the substituted advertisements can be optionally targeted to a specific end-user, who recorded the media broadcasts, which can result in increased revenue streams to the broadcaster, as typically directed advertising is more costly than undirected advertising. Alternatively, substituted advertisements can occur to maintain advertisement currency, as an original advertisement may include time sensitive or dated content no longer relevant at a time of playback.

The present invention may be embodied as a method, system, or computer program product. Accordingly, the present invention may take the form of an entirely hardware embodiment, a software embodiment (including firmware, resident software, micro-code, etc.) contained in a storage media or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. Any suitable computer usable or computer readable medium may be utilized. The computer-usable or computer-readable medium may be, for example but not limited to, an electronic, magnetic, optical, electromagnetic, infrared, or semiconductor system, apparatus, or device. Examples of a computer-readable medium include a semiconductor or solid state memory, magnetic tape, a removable computer diskette, a random access memory (RAM), a read-only memory (ROM), an erasable programmable read-only memory (EPROM or Flash memory), a rigid magnetic disk, and an optical disk. Current examples of optical disks include compact disk—read only memory (CD-ROM), compact disk—read/write (CD-R/W) and DVD.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

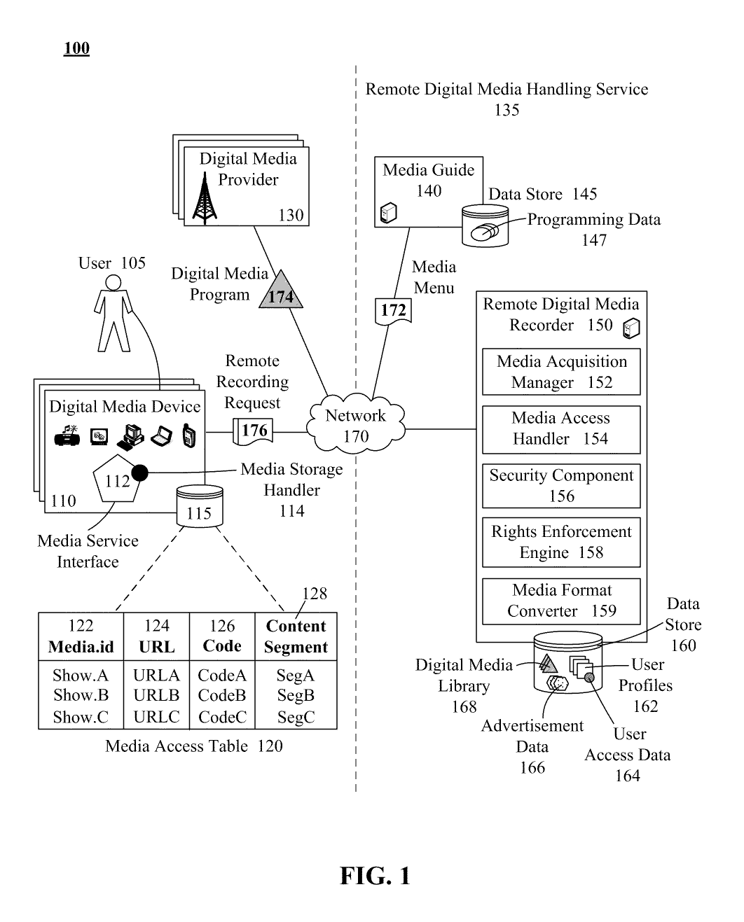

FIG. 1 is a schematic diagram illustrating a system 100 that provides device-independent remote recording/storage of digital media programs 174 in accordance with embodiments of the inventive arrangements disclosed herein. In system 100, a user 105 can utilize a remote digital media handling service 135 to perform a variety of functions, such as record, store, and/or access, for various digital media programs 174 broadcast by digital media providers 130.

The user 105 can interact with the remote digital media handling service 135 using a media service interface 112 running on a digital media device 110. In one embodiment, the media service interface 112 can have a “look-and-feel” of a digital video recording (DVR) interface, which has been extended to permit access to a remote data store 160. For example, the interface 112 can include an interactive broadcast guide, can allow a user to schedule recordings by time, channel, show, and the like, can permit a user to view a live show, can include functions to search for recorded media, and can permit playback of recorded media, which includes locally stored (in data store 115) media and remotely stored (in data store 160) media. A difference between locally stored media and remotely stored media may be user transparent or may be shown in interface 112 though a user viewable indicia, such as showing an icon or characteristic color scheme for network stored media. In one embodiment, the media service interface 112 can be a Web interface served from a Web server and rendered in a Web browser of device 110, which can therefore by any networked computing device equipped with a Web browser.

The digital media device 110 can represent a variety of electronic computing devices capable of supporting the media service interface 112 and communicating with the components of the remote digital media handling service 135 over a network 170. The digital media device 110 can include a local data store 115. For example, device 110 can include a DVR or a PVR device. Device 110 can also include a mobile phone, a portable media player, or other device that effectively functions as a media extender to a primary digital media device. In one embodiment, the primary digital media device can be the remote digital media recorder 150 and no discrete user 105 owned-maintained DVR device is needed.

The remote digital media handling service 135 can represent the hardware and/or software required to provide users 105 with a remote and device-independent means of handling digital media. That is, the remote digital media handling service 135 can represent a centralized means by which a user 105 can perform the functions supported in different manners by different digital media devices 110 and immediately share the resultant digital media without having to coordinate execution of the functions between the digital media devices 110.

For example, conventionally, the functions provided by a digital video recorder (DVR) can only be accessed by a user 105 when using the remote control and the television attached to a DVR. The remote digital media handling service 135 can allow the user 105 to use various other digital media devices 110 to request the remote digital media handling service 135 to perform the DVR functions; the requesting digital media device 110 is not required to natively include hardware and/or software components necessary to locally perform DVR functions. The digital media program 174 captured by such a request can then be shared among any other digital media devices 110 of the user's 105.

It should be noted that, although the file corresponding to a digital media program 174 captured by the remote digital media handling service 135 can be stored upon various digital media devices 110 having a local data store 115, playback of the captured digital media program 174 requires that the digital media device 110 include the hardware and/or software components that support playback of the captured digital media program 174. For example, an HD encoded program 174 can only be played by upon device 110 in HD fidelity, when such a capability is supported by device 110.

Unlike conventional recordings, the service 135 is not limited to explicit capabilities of the device 110 hosting the interface 112 though which a recording of a program 174 was scheduled. For example, service 135 can record a program 174 in multiple fidelities (HD, standard definition, low definition) and formats, which are each placed in data store 160. When playback is requested from device 110, a suitable fidelity and formatted media file can be provided by the service 135. Thus, even if a low fidelity device (e.g., a mobile phone including interface 112) is used to schedule a program 174 recording, a device upon which playback occurs (e.g., HD television) is not limited to viewing media customized for the comparably meager capabilities of the mobile device that scheduled the recording. Similarly, a mobile device requesting playback of media recorded via service 135 does not consume bandwidth and storage memory to attempt to receive a large media file that would be unsuitable for the mobile device.

The remote digital media handling service 135 can utilize a media guide 140 and a remote digital media recorder 150. The media guide 140 can represent hardware and/or software components configured to provide the user 105 (via interface 112) with a media menu 172 of available digital media. The media guide 140 can include a data store 145 containing programming data 147. The programming data 147 can be received from digital media providers 130 to which the remote digital media handling service 135 subscribes.

The media menu 172 can take a variety of forms depending on what type of information the user 105 requests to view. For example, the media menu 172 can represent a schedule of programming data 147 for digital media programs 174 from digital media providers 130 to which the remote digital media handling service 135 subscribes. This can be likened to the “Guide Channel” provided by many digital cable television providers that displays programming data 147.

However, the media menu 172 of the remote digital media handling service 135 can include multiple digital media types. That is, the “Guide Channel” only includes the digital cable television and radio channels broadcast by the digital cable television provider; the media menu 172 can be a compilation of digital television stations, digital radio stations, Internet Web sites that provide digital media (i.e., PODCASTS, streaming audio, streaming video, etc.), and the like.

The remote digital media recorder 150 can abstractly represent the hardware and/or software components configured to capture digital media programs 174 from the digital media providers 130. The remote digital media recorder 150 can include a variety of components, such as a media acquisition manager 152, a media access handler 154, a security component 156, a rights enforcement engine 158, a media format converter 159, and a data store 160.

In an alternate embodiment, the media acquisition manager 152, media access handler 154, security engine 156, rights enforcement engine 158, and media format converter 159 can reside on one or more different computing devices that are communicably linked. That is, the functions provided by media acquisition manager 152, media access handler 154, security component 156, rights enforcement engine 158, and media format converter 159 can be distributed over a network of computing devices that comprise the remote digital media recorder 150 and/or remote digital media handling service 135.

The data store 160 can contain user profiles 162, advertisement data 166, and a digital media library 168. The user profiles 162 can be configured to contain a variety of information about the user 105, such as identification of the digital media devices 110 of a user 105. A user profile 162 can also include user access data 164 that details what items of the digital media library 168 that the user 105 can access.

The digital media library 168 can represent an archive of digital media programs 174 captured by the remote digital media recorder 150. The digital media programs 174 can be contained within the digital media library 168 without association to the user 105 who originally requested capture. That is, the items of the digital media library 168 are not stored with any relationship to any user 105. As stated above, a user's 105 access to items within the digital media library 168 can be recorded in the user access data 164 of the user's 105 user profile 162.

By storing captured digital media programs 174 in the digital media library 168 without association with a specific user 105, redundant media captures can be greatly reduced. That is, a digital media program 174, for a given set of recording parameters, can be captured once and access to the corresponding media file can be given to multiple users 105 who request capture of the same digital media program 174 with identical recording parameters.

The advertisement data 166 can correspond to digitally-presented commercial advertisements, similar to television commercials and/or Web page banners. The advertisement data 166 can be dynamically integrated into digital media programs 174 when provided to the user 105. This can allow for newer advertisements to be incorporated into older recordings as well as targeted advertising based upon user profile 162 data.

In yet another embodiment, contents of the data store 160 can be expanded to include storage space for user-uploaded content (not shown). In such an embodiment, the user access data 164 can be used to record access information for sharing these additional digital media items between users 105.

The media acquisition manager 152 can represent the component of the remote digital media recorder 150 configured to obtain digital media programs 174 for fulfilling remote recording requests 175. To obtain a digital media programs, 174, the media acquisition manager 152 can be configured to search the digital media library 168 for a match before scheduling capture of the digital media program 174 from the corresponding digital media provider 130.

A match found within the digital media library 168 need not be exact. The media acquisition manager 152 can be further configured to utilize the media format converter 159 in cases where an existing item of the digital media library 168 can be converted to the format requested. The media format converter 159 can represent one or more software applications and/or components capable of transforming a digital media file from one format to another. For example, a digital media program 174 stored as a WINDOWS media file with an .AVI file extension can be converted to a Moving Pictures Expert Group (MPEG) version 4 media file having an .MP4 file extension.

Once the requested digital media program 174 is obtained by the remote digital media recorder 150, the media access handler 154 can provide the user 105 with access to the captured digital media program 174 within the digital media library 168. Preferences for accessing captured digital media programs 174 can be specified by the user 105 within their user profile 162. Access to the captured digital media programs 174 can be provided in a variety of ways, including, but not limited to, scheduled file downloads, electronic messaging, partial file downloads, media streaming, hyperlinks, combinations of access methods, and the like.

For example, the media access handler 154 can send the user 105 an email notification with a hyperlink to their requested digital media program 174. The user 105 can then use the hyperlink within the email to begin downloading the digital media program 174 to their digital media device 110.

The security component 156 can represent the hardware and/or software elements of the remote digital media recorder 150 that provide security functions, such as username/password validation and file privileges. For example, the security component 156 can deny access to remote recording requests 176 that originate from specific Internet Protocol (IP) addresses. Keys and/or certificates not requiring manual user input and/or derived from hardware identifiers of an approved device 110 are also contemplated. Further, encryption schemes can be implemented to encode information of data store 160 to ensure unauthorized access of stored information is prevented.

The rights enforcement engine 158 can represent the component of the remote digital media recorder 150 configured to oversee digital rights management (DRM). For example, the rights enforcement engine 158 can utilize data exchanges to ensure that multiple digital media devices 110 belonging to the user 105 are not concurrently playing the same digital media program 174.

In another contemplated embodiment, the remote digital media recorder 150 can be implemented as a multitude of computing devices. In such an embodiment, the multitude of computing devices can be separated into groups with each group configured to capture a specific type of digital media. For example, one such group could include personal computers with TV tuner cards connected to various cable television providers 130, and another group of personal computers could be connected to the Internet to capture other media, such as PODCASTS.

The user 105 can view the media menu 172 upon the digital media device 110 via the media service interface 112. The media service interface 112 can represent a software application providing one or more graphical user interfaces (GUIs) to facilitate interaction between the user 105 and the remote digital media handling service 135. For example, the media service interface 112 can present the user 105 with a categorical listing of the digital media library 168.

When the user 105 selects an option to record a digital media program 174 presented within the media menu 172, the media service interface 112 can generate a remote recording request 176. The remote recording request 176 can be conveyed to the remote digital media recorder 150 over the network 170. The remote recording request 176 can contain all the information necessary for the remote digital media recorder 150 to capture the digital media program 174, such as user identification, program name, name of the digital media provider 130, etc.

The media service interface 112 can include a media storage handler 114. The media storage handler 114 can correspond to a component of the media service interface 112 configured to handle transference and/or storage operations between the remote digital media handling service 135 and the local data store 115 of the digital media device 110. For example, the media storage handler 114 can initiate downloads from the remote digital media handling service 135 during periods of low bandwidth usage by the digital media device 110.

Depending on the preferences of the user 105, data from the remote digital media recorder 150 can be stored in a variety of ways. Since storage space is a concern for many digital media devices 110, access to items of the digital media library 168 can be stored local to the digital media device 110 in a media access table 120.

The media access table 120 can represent a space-conserving means for recording and providing access to items in the digital media library 168. As shown in this example, the media access table 120 can include data elements containing a media.id 122, a URL 124, a code 126, and a content segment 128 for captured digital media programs 174. These data elements 122, 124, 126, and 128 can be utilized by the media service interface 112 and/or media storage handler 114 to facilitate access.

The media.id 122 can correspond to the unique identifier of the digital media program 174 stored within the digital media library 168. The URL 124 can define the location of the digital media program 174 within the digital media library 168. The code 126 can represent a unique text string that can be validated by the remote digital media recorder 150. The content segment 128 can be a portion of the digital media program 174 that has been downloaded to the digital media device 110.

For example, the user 105 can view the content segment 128 for ShowA and decide to access the remainder of ShowA from the media service interface 112. The media service interface 112 can then use the URL 124 and code 126 to access the item within the digital media library 168 having the same media.id 122.

It should be noted that complexity of the remote digital media handling service 135 is transparent to the user 105. That is, from the user's 105 perspective, the user 105 simply selects digital media programs 174 to be remotely recorded via the media service interface 112 and is then able to access the captured digital media programs 174 from various digital media devices 110. The user 105 is not required to understand or perform technical operations that are typically required when working with digital media devices 110 of differing capabilities.

As used herein, presented data stores 115, 140, and 160 can be a physical or virtual storage space configured to store digital information. Data stores 115, 140, and 160 can be physically implemented within any type of hardware including, but not limited to, a magnetic disk, an optical disk, a semiconductor memory, a digitally encoded plastic memory, a holographic memory, or any other recording medium. Data stores 115, 140, and 160 can be a stand-alone storage unit as well as a storage unit formed from a plurality of physical devices. Additionally, information can be stored within data stores 115, 140, and 160 in a variety of manners. For example, information can be stored within a database structure or can be stored within one or more files of a file storage system, where each file may or may not be indexed for information searching purposes. Further, data stores 115, 140, and/or 160 can utilize one or more encryption mechanisms to protect stored information from unauthorized access.

The network 170 can include any hardware/software/firmware necessary to convey digital content encoded within carrier waves. Content can be contained within analog or digital signals and conveyed through data or voice channels and can be conveyed over a personal area network (PAN), a local area network (LAN), or a wide area network (WAN). The network 170 can include local components and data pathways necessary for communications to be exchanged among computing device components and between integrated device components and peripheral devices. The network 170 can also include network equipment, such as routers, data lines, hubs, and intermediary servers which together form a packet-based network, such as the Internet or an intranet. The network 170 can further include circuit-based communication components and mobile communication components, such as telephony switches, modems, cellular communication towers, and the like. The network 170 can include line based and/or wireless communication pathways.

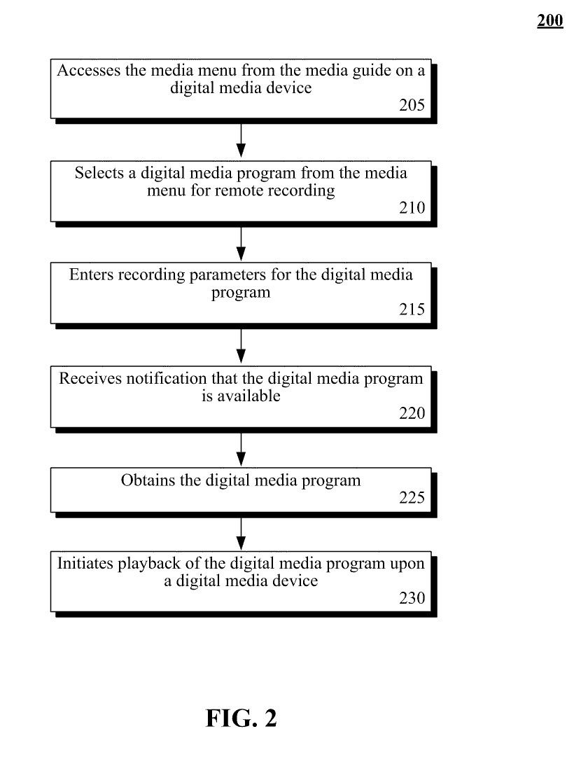

FIG. 2 is a flowchart of a method 200 detailing use of the remote digital media handling service from the user's perspective in accordance with embodiments of the inventive arrangements disclosed herein. Method 200 can be executed within the context of system 100.

Method 200 can begin with step 205 where the user can access the media menu from the media guide on a digital media device. The user can select a digital media program for remote recording from the media menu in step 210. In step 215, the user can enter recording parameters for the digital media program. Examples of recording parameters can include, but, are not limited to, a digital media format, a resolution size, a target digital media device, subtitle usage, and the like.

The user can receive notification that the digital media program is available in step 220. It is important to note that the amount of time that passes between steps 215 and 220 can vary. For example, if the digital media program already exists within the digital media library that matches the user's recording parameters, then step 220 occurs much sooner than if the digital media program must be captured at the specified date and time.

In step 225, the user can obtain the digital media program. Playback of the digital media program upon a digital media device can be initiated in step 230.

It should be emphasized that the digital media device used in step 230 need not be the same digital media device that was used in steps 205, 210, and 215. A conventional digital video recorder (DVR) system often requires a single specialized interface, which cannot be accessed or utilized by other digital media devices. Further, sharing digital media programs captured by a conventional DVR system typically requires additional knowledge of the capabilities of the digital media device and operations to transform the captured digital media program into the appropriate format. Method 200 is not confined by these limitations.

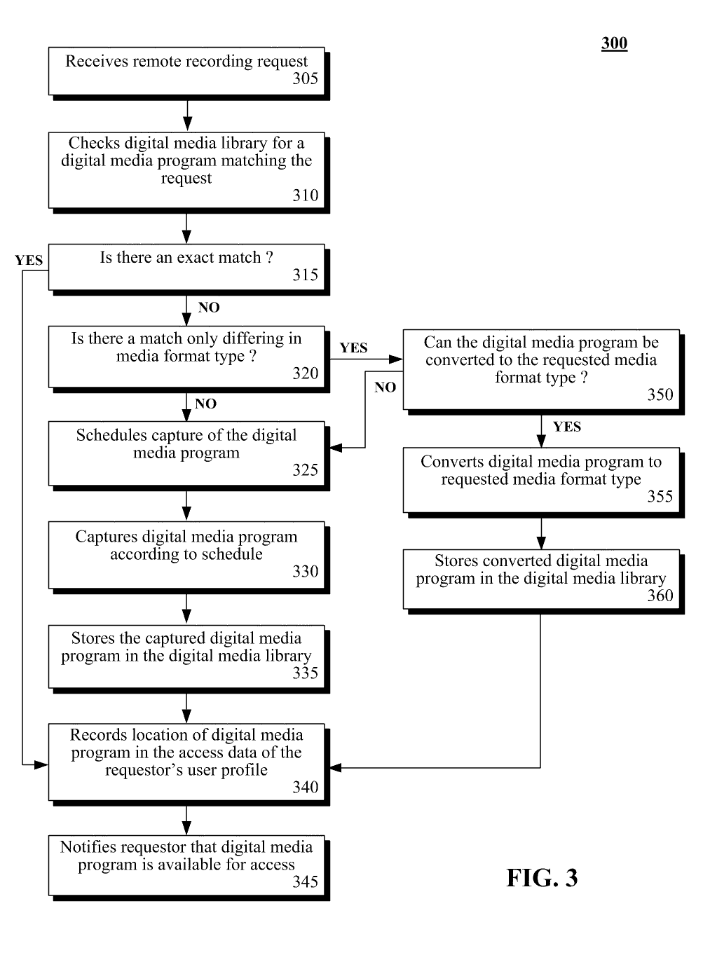

FIG. 3 is a flow chart of a method 300 that describes the capture of digital media programs by the remote digital media recorder in accordance with an embodiment of the inventive arrangements disclosed herein. Method 300 can be performed within the context of system 100 and/or method 200.

Method 300 can begin with step 305 where the remote digital media recorder can receive a remote recording request. The digital media library can be checked for a digital media program that matches the request in step 310. In step 315, it can be determined if an exact match exists within the digital media library.

When an exact match does not exist, step 320 can execute where it can be determined if a match exists whose only difference is the media format type. When a match differing in media format type exists, step 350 can execute where it can be determined if the existing digital media program can be converted to the media format type in the remote recording request.

When the existing digital media program can be converted, the digital media program can be converted to the requested media format type in step 355. In step 360, the converted digital media program can be stored in the digital media library. From step 360, flow can proceed to step 340.

When the existing digital media program cannot be converted, the remote digital media recorder can schedule the digital media program for capture in step 325. According to the schedule, step 330 can execute where the digital media program can be captured. The captured digital media program can then be stored in the digital media library in step 335.

When the remote digital media recorder does not find an exact match in step 315 or after execution of step 360 or 335, step 340 can execute where the location of the captured digital media program within the digital media library can be recorded in the access data of the requesting user's user profile. The user can then be notified that the digital media program is available for access in step 345.

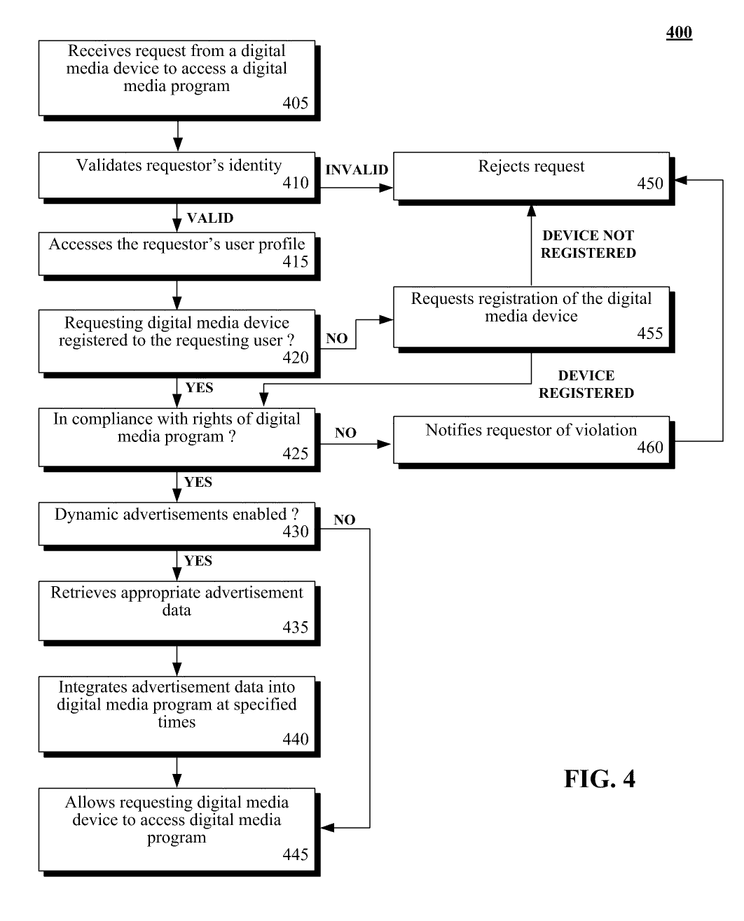

FIG. 4 is a flow chart of a method 400 detailing the provision of captured digital media programs by the remote digital media recorder in accordance with an embodiment of the inventive arrangements disclosed herein. Method 400 can be performed within the context of system 100 and/or methods 200 and 300.

Method 400 can begin with step 405 where the remote digital media recorder can receive a request from a digital media device to access a captured digital media program. The requesting user's identity can be validated in step 410. When the user's identity is invalid, step 450 can execute where the request can be rejected.

When the user's identity is valid, the requesting user's user profile can be accessed in step 415. In step 420, it can be determined if the requesting digital media device is registered to the requesting user. When the digital media device is not registered to the requesting user, step 455 can execute where the remote digital media recorder can request that the user register the digital media device.

When the user opts to not register the digital media device, flow can proceed to step 450 where the request can be rejected. When the user registers the digital media device or when the digital media device is already registered to the user, step 425 can execute where compliance with the rights of the digital media program can be determined.

When noncompliance is determined, the requesting user can be notified of the violation in step 460. From step 460, step 450 can then execute to reject the access request. When access complies with the rights of the digital media program, step 430 can execute where it can be determined if dynamic advertisements are enabled.

When the use of dynamic advertisements is enabled, the appropriate advertisement data can be retrieved in step 435. In step 440, the retrieved advertisement data can then be integrated into the digital media program at specified times. Upon completion of step 440 or when use of dynamic advertisements is not enabled, step 445 can execute where the requesting digital media device is allowed to access the digital media program.

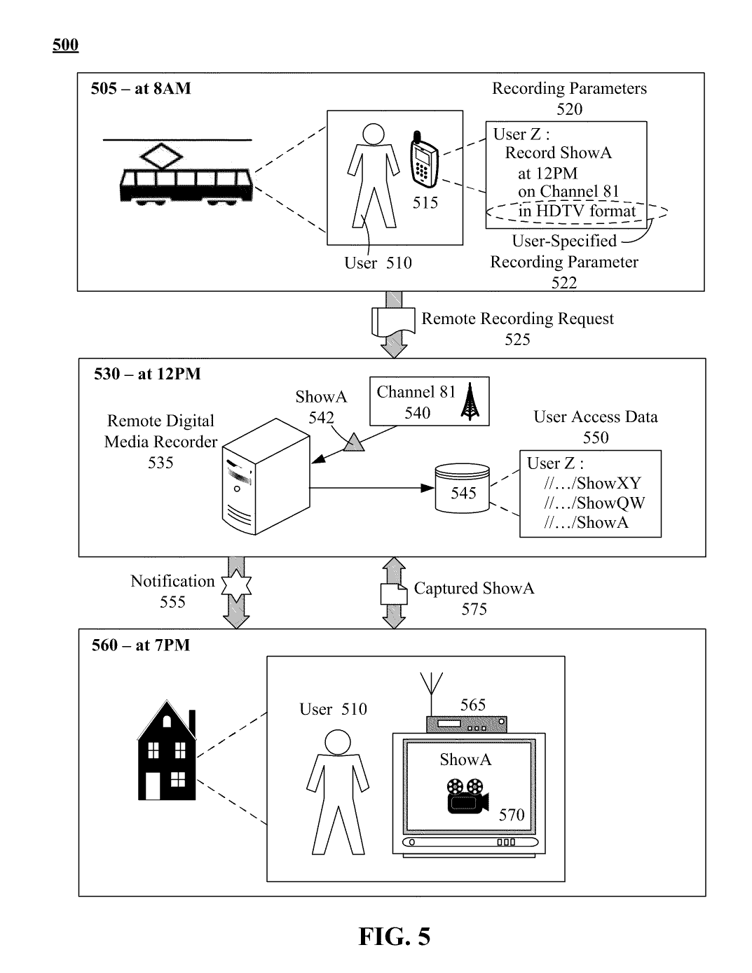

FIG. 5 is an illustrated sequence 500 of interactions 505, 530, and 560 depicting use of the remote digital media handling service in accordance with embodiments of the inventive arrangements disclosed herein. The illustrated sequence 500 can be performed within the context of system 100 and/or utilizing methods 200, 300, and 400.

It should be noted that the interactions 505, 530, and 560 of sequence 500 are for illustration purposes only, and are not meant as a limitation to an embodiment of the present invention.

In sequence 500, interaction 505 can occur first, followed by interaction 530, which can then be followed by interaction 560. Interaction 505 can illustrate a user 510 using a smart phone 515 while traveling to work. Using the smart phone 515, the user 510 can access the remote digital media handling service and elect to remotely record a digital media program.

Setting up the remote recording of the digital media program can generate recording parameters 520. The recording parameters 520 can represent the data that defines how the remote digital media recorder is to capture the digital media program. As shown in this example, the recording parameters 520 indicate that the user 510, identified as “User Z”, wants to record ShowA that is playing at 12 PM on Channel 81 in the high-definition (HD) format 522.

The recording parameters 520 can include one or more user-specified recording parameters 522. The user-specified recording parameters 522 can represent conditions of the recording process that the user 510 is able to configure. In this example, the user-specified recording parameter 522 relates to the format in which the user 510 wants to record the digital media program.

This can allow the user 510 to specify a media format that is different from the capabilities of digital media device being used to set up the recording, in this example a smart phone 515. That is, the recording parameters 520 and/or user-specific recording parameters 522 can be specified for the digital media device upon which the user 510 intends to view the captured digital media program and not necessarily the digital media device 515 being used to set up the recording.

Once the user 510 is finished, the recording parameters 520 can be conveyed to the remote digital media handling service as a remote recording request 525.

Interaction 530 can represent the actions performed by the remote digital media handling service to fulfill the user's 510 remote recording request 525. In this example, the requested digital media program does not already exist within the digital media library, and must be captured. Thus, interaction 530 can occur at the time specified in the remote recording request 525—12 PM.

At this time, the remote digital media recorder 535 can access the digital media provider 540 that broadcasts Channel 81. ShowA 542 can then be captured by the remote digital media recorder 535 and stored in the data store 545. The user access data 550 for User Z can then be modified to include information for ShowA 542 and a notification 555 can be conveyed to the user 510.

It should be noted that neither the digital media device used to set up the remote recording nor the digital media device to be used to view the digital media program need to be in communication with the remote digital media handling service during interaction 530.

Interaction 560 can occur anytime after interaction 530. In this example, interaction 560 occurs at 7 PM when the user 510 has arrived home. In another example, it can occur immediately after the show 542 broadcasts ends, so that it is locally stored in device 565 before user 510 has arrived in their house. In still another example, the media can largely remain on the networked storage device 545 and be streamed to device 565 at a time of request. In interaction 560, the user 510 can use a network-capable digital media device 565 connected to a television 570 to access and view the captured ShowA 575.

As used herein, presented data store 545 can be a physical or virtual storage space configured to store digital information. Data store 545 can be physically implemented within any type of hardware including, but not limited to, a magnetic disk, an optical disk, a semiconductor memory, a digitally encoded plastic memory, a holographic memory, or any other recording medium. Data store 545 can be a stand-alone storage unit as well as a storage unit formed from a plurality of physical devices. Additionally, information can be stored within data store 545 in a variety of manners. For example, information can be stored within a database structure or can be stored within one or more files of a file storage system, where each file may or may not be indexed for information searching purposes. Further, data store 545 can utilize one or more encryption mechanisms to protect stored information from unauthorized access.

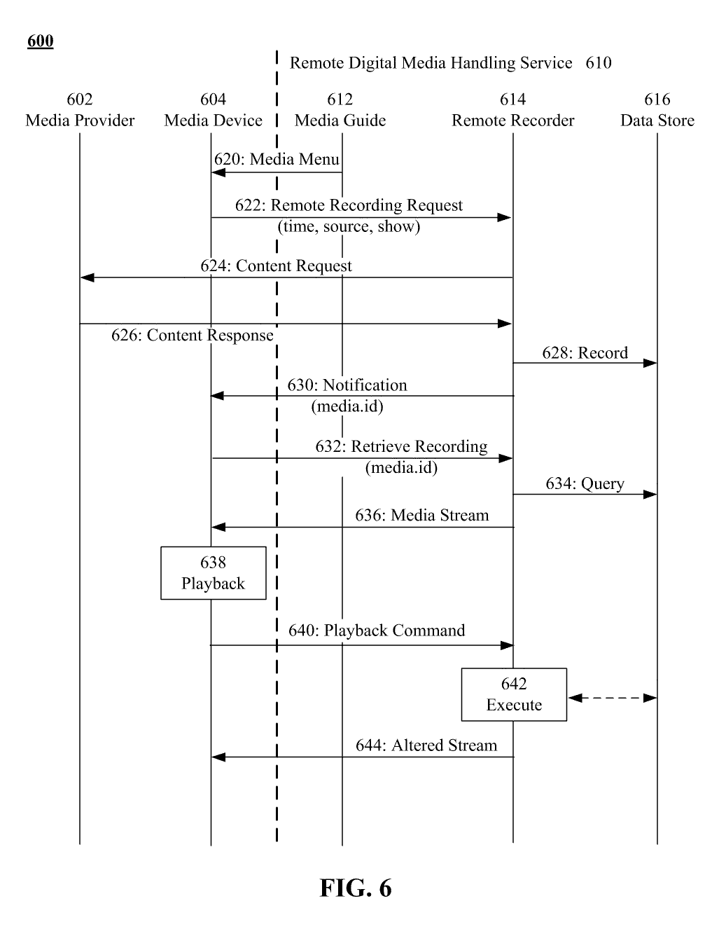

FIG. 6 is a communication flow 600 between the entities involved in the remote recording of digital media programs in accordance with embodiments of the inventive arrangements disclosed herein. The entities involved in communication flow 600 can include the media provider 602, the media device 604, and the remote digital media handling service 610. The remote digital media handling service 610 can include the media guide 612, the remote recorder 614, and a data store 616.

Communication flow 600 can begin with the media device 604 receiving the media menu 620 from the media guide 612. The media device 604 can then send a remote recording request 622 to the remote recorder 614.

At the specified date and time, the remote recorder 614 can send a content request 624 to the media provider 602. The media provider 602 can then provide the remote recorder 614 with a content response 626. The remote recorder 614 can then record 628 the content from the media provider 602 in the data store 616.

The remote recorder 614 can then send the media device 604 a notification 630. The notification 630 can include a media.id for accessing the captured program. At a point in time after the notification 630 has been sent, the remote recorder 614 can received a retrieve recording request 632 from the media device 604. The retrieve recording request 632 can include the media.id from the notification 630.

The remote recorder 614 can query 634 the data store 616 for the captured program. The captured program can then be provided by the remote recorder 614 as a media stream 636 to the media device 604. Playback 638 of the media stream 636 can then occur upon the media device 604.

The media device 604 can send the remote recorder 614 an optional playback command 640, such as a rewind command. The remote recorder 614 can execute 642 the received playback command 640. Depending on the playback command 640, the remote recorder 614 can be required to access the data store 616. Once execution 642 of the playback command 640 is complete, the altered stream 644 corresponding to the captured program can continue to be conveyed to the media device 604.

It should be noted that communication flow 600 illustrates a playback command 640 that requires action by the remote recorder 614, such as fast-forwarding or rewinding. Communication flow 600 can accommodate other playback commands 640 that may not require modification of the media stream 636 and/or action by the remote recorder 614, such as pause.

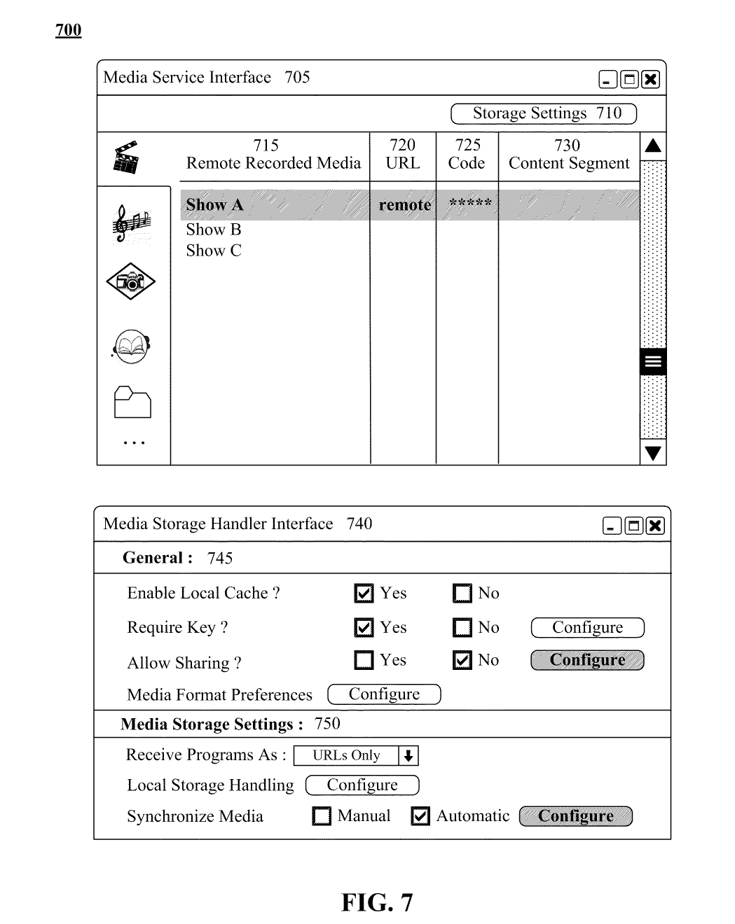

FIG. 7 is a collection 700 of graphical user interfaces (GUIs) 705 and 740 for interacting with the remote digital media handling service in accordance with embodiments of the inventive arrangements disclosed herein. The GUIs 705 and 740 of collection 700 can be utilized by system 100 and/or in the conduction of method 200. It should be noted that the GUIs 705 and 740 of collection are for illustrative purposes only and are not meant as limitations to the implementation of an embodiment of the present invention.

Collection 700 can include GUIs illustrating the media service interface 705 and the media storage handler interface 740. Both GUIs 705 and 740 can operate from the user's digital media device. GUIs 705 and 740 can be implemented in a variety of ways, including, but not limited to, a Web application, a client application, a thin client, a stand-alone application, and the like.

The media service interface 705 can be configured to provide the user with a variety of information about the remote digital media handling service. In this example, the media service interface 705 can present the user with information about the digital media programs they have remotely recorded, such as the data contained in the media access table 120 of system 100.

As such, the media service interface 705 can display the identifiers of the remote recorded media 715 and the URL 720, code 725, and/or content segment 730 corresponding to the remote recorded media 715. The user can then utilize the input mechanism of the digital media device presenting the media service interface 705 to perform associated operations.

The media service interface 705 can also include a means for accessing the settings of the media storage handler, such as the storage settings button 710. Selection of the storage settings button 710 can result in presentation of the media storage handler interface 740.

The media storage handler interface 740 can provide the user with the means to establish preferences for managing access to their remotely stored media and/or synchronization of their remotely stored media with the local storage of their digital media device. In this example, the media storage handler interface 740 contains general settings 745 and media storage settings 750.

These settings 745 and 750 can include conditions that can be applied at a global level as well as device level. For example, the “Require Key?” setting can be applied to all the user's digital media devices, whereas the “Local Storage Handling” setting would be applied to only the digital media device running the media storage handler interface 740. The media storage handler interface 740 can include visual and/or textual differentiation to distinguish between global and device-specific settings 745 and 750.

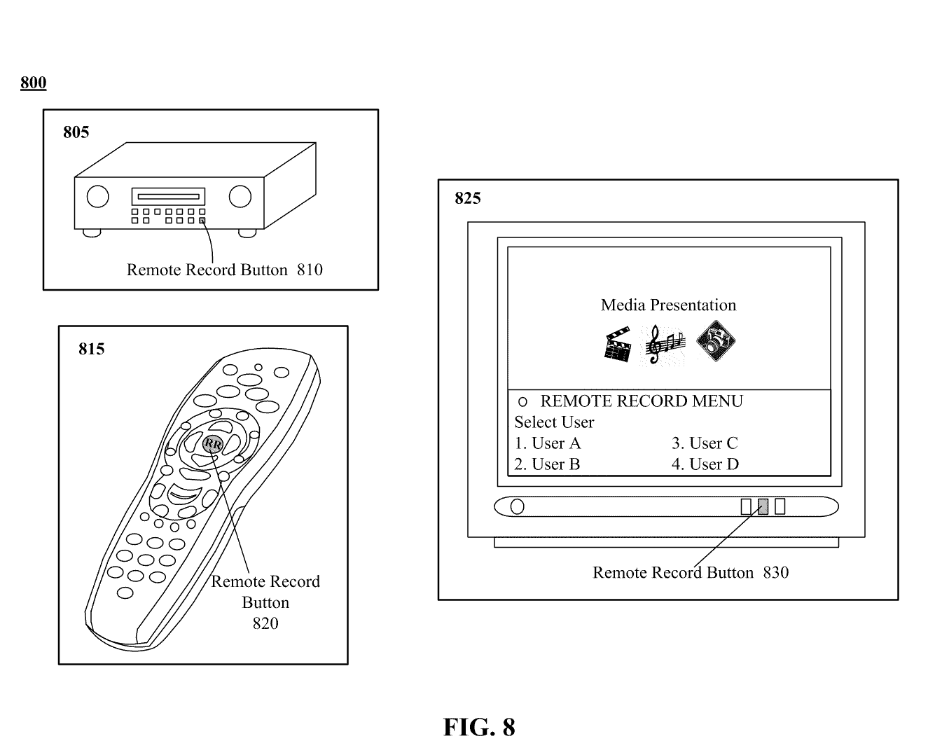

FIG. 8 is a collection 800 of digital media device components 805, 815, and 825 that incorporate hardware mechanisms for accessing the remote digital media handling service in accordance with embodiments of the inventive arrangements disclosed herein. It should be noted that the digital media device components 805, 815, and 825 of collection 800 are for illustrative purposes only and are not meant to present comprehensive embodiments.

Digital media device component 805 can correspond to a DVR or digital cable television receiver. In addition to the digital media device component's 805 standard features, this digital media device component 805 can include a remote record button 810. The remote record button 810 can allow the user to access the functions of the remote digital media handling service upon a display device (not shown) connected to the digital media device component 805.

Digital media device component 815 can represent a remote control in which a remote record button 820 has been incorporated. It should be noted that the device associated with the remote control 815 must be capable of interpreting and executing instructions related to the remote record button 820 and the remote digital media handling service.

Digital media device component 825 can represent a television set having an integrated remote record button 830 for accessing the remote digital media handling service. The television 825 can be configured to contain the additional components required for accessing the remote digital media handling service.

The diagrams in FIGS. 1-8 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A software implemented remote digital media handling service implemented in a computer program product digitally recorded in a storage medium executable by a processor, said service comprising:
receiving a remote recording request digitally conveyed over a public IP network from a requesting device;
determining from digital information encoded in the remote recording request an identifier for an end-user originating the remote recording request and a digital media program identifier, wherein the digital media program identifier is for an upcoming to be broadcast program having a broadcast start time and a broadcast channel;
scheduling a triggerable recordation event for recording the broadcast program established for a networked computing device remotely located from the requesting device;
detecting a clock reaching a time approximately equal to the broadcast start time and responsively firing the recordation event with the networked computing device;
recording the broadcast program as a digital media file to a networked data store along with an index to the identifier for the end user and a media index that uniquely identifies said digital media file;
conveying the media index over the public IP network to the requesting device;
receiving a playback request digitally conveyed over the public IP network from a playback device;
determining from digital information encoded in the playback request the media index and an identifier for the end-user;
confirming the end-user is to be granted access to the digital media file by querying the networked data store and ensuring the index for the end-user is associated with the stored digital media file; and
conveying the digital media file over the public IP network for playback on the playback device.

2. The service of claim 1, wherein the requesting device and the playback device are the same device, said device being a computing device comprising a media service interface through which the remote recording request was issued and through which the playback request was issued responsive to manually entered user input.

3. The service of claim 1, wherein the requesting device and the playback device are different devices, said confirming the end-user further comprising:
confirming that the playback device is associated with the user before conveying the digital media file over the public IP network.

4. The service of claim 1, wherein said playback device comprises a local data store for storing a plurality of digital media files, said service further comprising:
subsequent to recording the broadcast program and before receiving the playback request, conveying an initial portion of the digital media file over the public IP network from the networked data store to the local data store of the playback device, wherein said initial portion has a size of less than half the size of said digital media file; and
conveying a termination portion of the digital media file over the public IP network from the networked data store to the playback device after receiving the playback request, whereby playback from the playback device commences from the initial portion immediately upon user selection, and wherein the terminal portion is conveyed to the playback device while the initial portion is playing, which saves space on the local data store while ensuring responsiveness from an end-user perspective.

5. The service of claim 1, further comprising:
determining from digital information encoded in the playback request or from stored information in the networked data store indexed against the user specific settings of said end-user, a desired format and fidelity for the digital media file; and
identifying one of a plurality of previously stored versions of the digital media file that has the desired format and fidelity or converting a stored version of the digital media file to the desired format and fidelity before conveying the digital media file over the public IP network for payback, wherein the conveyed digital media file has said desired format and fidelity.

6. The service of claim 1, further comprising:
upon receiving the playback request and before conveying the digital media file, determining at least one advertisement that was not originally broadcasted with the broadcast program;
adding the determined at least one advertisement to the digital media file in place of at least advertisement that was originally broadcasted with the broadcast program; and
conveying the digital media file that comprises the added at least one advertisement to the playback device.

7. The service of claim 1, wherein the playback device comprises a local data store comprising a plurality of digital media files, said service comprising:
detecting at the networked computing device a synchronization event occurrence to synchronize the local data store of the playback device with the networked data store;
responsive to the synchronization event, copying at least one of said plurality of digital media files of the local data store to the networked data store and indexing the copied media files against the identifier for the end-user so that the copied media files are able to be removed from the local data store to free up storage space of the local data store;
conveying the media indexes for the copied media files over the public IP network to the playback device so that an end-user of the playback device is able to reference the copied media files via the media indexes to the networked data store;
responsive to the synchronization event, copying at least one of a plurality of digital media files that are indexed to the identifier for the end user from the networked data store to the local data store; and
subsequent to the copying of the digital media files from the networked data store, removing the copied digital media files as indexed against the identifier for the end user from the networked data store.

8. A digital media device comprising:
hardware and computer program products digitally stored in a storage medium and executable on said hardware to time-shift broadcasted digital media programs that are broadcasted for television receivers by digitally storing digital media files of user selected ones of the digital media programs, wherein said hardware and computer program products enable playback of stored ones of the digital media files at a user selected time, said hardware and computer program products comprising:
a media service interface for interfacing with an end user, said media service interface comprising:
a media guide screen for displaying a media menu showing upcoming media program broadcasts, which are able to be selected for recording via the media service interface;
a recorded program screen for selecting previously recorded digital media files for playback, said recorded program screen showing digital media files stored in a local data store as well as digital media files stored in a remotely located, networked data store; and
a playback screen for showing videos for recorded digital media files selected via the recorded program screen;
a network interface component for connecting the digital media device to a public IP network; and
the local data store for storing a plurality of digital media files, said local data store further comprising a media access table, said media access table comprising a plurality of records for digital media files stored in the local data store and for digital media files stored in the remotely located, networked data store that are accessible via the public IP network to which the network interface connects, wherein each of said plurality of media records is for a previously recorded digital media file that was recorded responsive to user selections via the media guide screen, wherein each of the plurality of records is used to populate one of the digital media files of the recorded program screen, wherein a local plurality of said media records are for digital media files stored on the local data store, wherein a remote plurality of said media records are for digital media files stored on the networked data store, wherein none of the digital media files of the remote plurality are stored in their entirety within the local data store yet each are able to be played upon the playback screen responsive to a user selection of the associated digital media file made in the recorded program screen.

9. The digital media device of claim 8, wherein the digital media device is a specialized computing device that is a digital video recorder designed to be directly coupled to a television, wherein the computer program products are stored upon said digital video recorded in a manner designed to inhibit their removal by an end-user and to inhibit user modifications of the computer program products other than computer program product upgrades explicitly approved by an authorized digital video recorder agent.

10. The digital media device of claim 8, each of said remote plurality of media records comprising, a unique identifier for the networked data store containing the digital media record, a media index that is a unique identifier for a corresponding digital media file stored in the networked data store, and a name of the digital media file, which is presented in the recorded program screen.

11. The digital media device of claim 10, wherein each of the media records of the remote plurality of media records comprises a uniform resource locator (URL) that uniquely identifies the networked data store or that uniquely identifies one of the digital media files stored in the networked data store.

12. The digital media device of claim 8, said local data store comprising a plurality of initial portions of digital media files, wherein each initial portion has a size of less than half the size of the corresponding complete digital media file, wherein each of the initial portions is associated with one record in the remote plurality of media records, wherein a user selection of one of the shown digital media files associated with the remote plurality of media records via the recorded program screen results in a triggering of one of the computer program products executing on the hardware that causes the corresponding initial portion in the local data store to immediately play in the playback screen, and causes the digital media device to initiate a download of at least a terminal portion of the selected digital media file from the networked data store over a public IP network while the initial portion is playing within the playback screen.

13. The digital media device of claim 8, further comprising:
a computer program product for moving digital media files from the local data store to the networked data store and from the networked data store to the local data store based upon computer program product determined likelihood of a digital media file being accessed, wherein the computer program product when executed by the hardware ensures that a set of digital media files having a greatest determined likelihood of being accessed are stored in the local data store and those with a lesser likelihood of being accessed are remotely stored in the networked data store.

14. The digital media device of claim 8, said a media service interface further comprising:
an option to enable and disable sharing of the previously recorded digital media files so that the previously recorded media files shown in the recorded program screen are accessible from a device other than the digital media device.

15. The digital media device of claim 8, said computer program products when executing on said hardware permitting a selection of a plurality of different fidelities and formats for digital media files stored on the networked data store so that an optimal fidelity and format of a digital media file is always used when video is shown in the playback screen, wherein each digital media file of the networked data store is stored in a plurality of different fidelities and formats by default.

16. A remote digital media recorder comprising hardware and computer program products digitally stored in a storage medium and executable on said hardware, said computer program products when executing enabling the remote digital media recorder to:
receive selections of digital media program from a plurality of remotely located digital media devices, each digital media program being a scheduled-for-broadcast program for television receivers;
schedule recordings for the broadcasts for which selections were received;
record scheduled broadcasts on a network data store, wherein each recorded scheduled broadcast is stored in a plurality of different digital media files having different fidelities and formats;
index stored digital media files against requesters from whom the selections were received;
selectively provide stored digital media files only to those requesting users who are indexed against the stored digital media files and to users explicitly designed by one of the requesters as having access to the stored digital media files;
upon receiving a playback request for a stored digital media file by an authorized requester, determine stored one of the digital media files having a fidelity and format most optimal for a playback device of the authorized requester; and
provide the stored digital media file to the requestor in the optimal fidelity and format.

17. The remote digital media recorder of claim 16, wherein at least a portion of said digital media device from which selections are received comprise networked enabled digital video recorders designed to extend their storage capabilities utilizing the networked data store, said computer program products comprising:
a media acquisition manager for receiving the selections of the digital media programs, for scheduling recordings of the broadcasts to fulfill the received selections, and for indexing stored digital media files against requester from whom the selections were received;
a media access handler for selectively providing stored digital media files only to those requesting users who are indexed against the stored digital media files and to users explicitly designed by one of the requesting users as having access to the stored digital media files; and
a media format converter for transforming digital media files stored in the network data store from one format to another.

18. The remote digital media recorder of claim 16, said computer program products comprising:
a security component for providing security functions to limit access to stored digital media files in the networked data store to a set of authorized requesters defined by established programmatic rules; and
a rights enforcement engine for overseeing and enforcing digital rights management (DRM) usage limitations imposed upon the digital media files.

19. The remote digital media recorder of claim 16, said network data store comprising advertising data and user profiles, wherein said computer program product when executed by said hardware adds advertising data targeted a requester based upon data in the user profile of the requester to the provided stored digital media file responsive to receipt of the playback request.

20. The remote digital media recorder of claim 16, wherein said network data store provides only a terminal portion of the stored digital media file to the requester upon receiving the playback request, wherein an initial portion of the stored media file is stored in a data store local to the remotely located digital media device of the requestor.
